(19) United States
(12) Patent Application Publication
(10) Pub. No.: US 2013/0257927 A1
(43) Pub. Date: Oct. 3, 2013

(54) DISPLAY HAVING LIGHTING DEVICES INTEGRATED WITH AN E-BOOK AND DRIVING METHOD THEREOF

(71) Applicant: WINTEK CORPORATION, Taichung City (TW)

(72) Inventors: Wen-Chun Wang, Taichung City (TW); Ting-Yu Chang, Kaohsiung City (TW); Wen-Tui Liao, Taichung City (TW); Hsi-Rong Han, Taichung City (TW); Ching-Fu Hsu, Taichung City (TW)

(73) Assignee: WINTEK CORPORATION, Taichung City (TW)

(21) Appl. No.: 13/853,021

(22) Filed: Mar. 28, 2013

(30) Foreign Application Priority Data
Apr. 3, 2012 (TW) 101111826

(51) Int. Cl. G09G 5/10; G02F 1/133

(52) U.S. Cl. CPC G09G 5/10; G02F 1/13306
USPC 345/691; 349/33; 345/690

(57) ABSTRACT

A display having lighting devices integrated with an E-Book includes a display panel, and the display panel includes a plurality of pixels. Each pixel of the plurality of pixels includes a control unit, a lighting device driving unit, a first switch unit, a second switch unit, and an E-Book unit. The lighting device driving unit includes a lighting device. The control unit, the lighting device driving unit, the first switch unit, the second switch unit, and the E-Book unit are used for performing corresponding operations to let the lighting device or the E-Book unit properly display an image corresponding to an image signal when the display receives the image signal.

### BACKGROUND OF THE INVENTION

1. Field of the Invention

The present invention relates to a display and a driving method, and particularly to a display having lighting devices integrated with an E-Book and a driving method for driving display having lighting devices integrated with an E-Book.

2. Description of the Prior Art

Nowadays, a reflective panel (e.g. a polymer-dispersed liquid crystal (PDLC) panel or a cholesteric liquid crystal (CHLC) panel) and an organic light-emitting diode (OLED) panel are gradually popular, where the OLED panel has high color saturation, so the OLED panel is proper to display high-definition videos and animations, but the reflective panel is proper for an E-Book. When the OLED panel plays a role of display for application of an E-Book, user' s eyes feel tired easily because of the high color saturation of the OLED panel when the user views the OLED panel for a long time; when the reflective panel plays a role of display for displaying a high-definition video and an animation, the reflective panel has poorer performance because of a slower reaction time of the reflective panel.

### SUMMARY OF THE INVENTION

An embodiment provides a display having lighting devices integrated with an E-Book. The display includes a display panel, where the display panel includes a plurality of pixels. Each pixel of the plurality of pixels includes a control unit, a lighting device driving unit, a first switch unit, a second switch unit, and an E-Book unit. The lighting device driving unit includes a lighting device, and the lighting device driving unit is coupled to a first voltage terminal and a second voltage terminal respectively for generating a driving current. The control unit is coupled to the lighting device driving unit, where the control unit is controlled by a scan signal and used for storing a data signal. The first switch unit is coupled between the control unit and the E-Book unit, and the first switch unit includes a control terminal coupled to the first voltage terminal. The second switch unit is coupled between the E-Book unit and a third voltage terminal, and the second switch unit includes a control terminal coupled to the second voltage terminal. The lighting device driving unit generates the driving current to drive the lighting device, and the E-Book unit stores a third voltage signal received by the third voltage terminal when the first voltage terminal and the second voltage terminal receive a first low voltage signal and a second high voltage signal, respectively; and the E-Book unit receives the data signal when the first voltage terminal and the second voltage terminal receive a first high voltage signal and a second low voltage signal, respectively.

Another embodiment provides a driving method for driving a display having lighting devices integrated with an E-Book. Each pixel of the display includes a control unit, a lighting device driving unit, a first switch unit, a second switch unit, and an E-Book unit, where the lighting device driving unit includes a lighting device. The driving method includes receiving image data; a generating a first voltage signal, a second voltage signal, and a third voltage signal according to the image data; and the control unit, the lighting device driving unit, the first switch unit, the E-Book unit, and the second switch unit executing corresponding operations according to the first voltage signal, the second voltage signal, and the third voltage signal.

The present invention provides a display having lighting devices integrated with an E-Book and a driving method for driving a display having lighting devices integrated with an E-Book. The display and the driving method utilize a timing controller to generate a corresponding first voltage signal, a corresponding second voltage signal, and a corresponding third voltage signal according to different image data (e.g. image data corresponding to the lighting device or image data corresponding to the E-Book). Then, a control unit, a lighting device driving unit, a first switch unit, and a second switch unit can generate a driving current to drive a lighting device, or charge an E-Book unit to a corresponding gray-level voltage according to the corresponding first voltage signal, the corresponding second voltage signal, the corresponding third voltage signal, and a data signal of a corresponding data line. Thus, compared to the prior art, the present invention can utilize advantages of a reflective panel and a lighting device panel in the same panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a display having lighting devices integrated with an E-Book according to an embodiment.

FIG. 2 is a diagram illustrating a pixel.

FIG. 3 is a diagram illustrating a cross-section of the pixel.

FIG. 4 is a timing diagram illustrating the first voltage signal on the first voltage terminal, the second voltage signal on the second voltage terminal, and the third voltage signal on the third voltage terminal when the image data corresponds to the lighting device.

FIG. 5 is a timing diagram illustrating the first voltage signal on the first voltage terminal, the second voltage signal on the second voltage terminal, and the third voltage signal on the third voltage terminal when the image data corresponds to the E-Book unit.

FIG. 6 is a diagram illustrating a cross-section of a pixel according to another embodiment.

FIG. 7 is a timing diagram illustrating the first voltage signal on the first voltage terminal, the second voltage signal on the second voltage terminal, and the third voltage signal on the third voltage terminal when image data corresponds to the lighting device.

FIG. 8 is a flowchart illustrating a driving method for driving a display having lighting devices integrated with an E-Book according to another embodiment.

### DETAILED DESCRIPTION

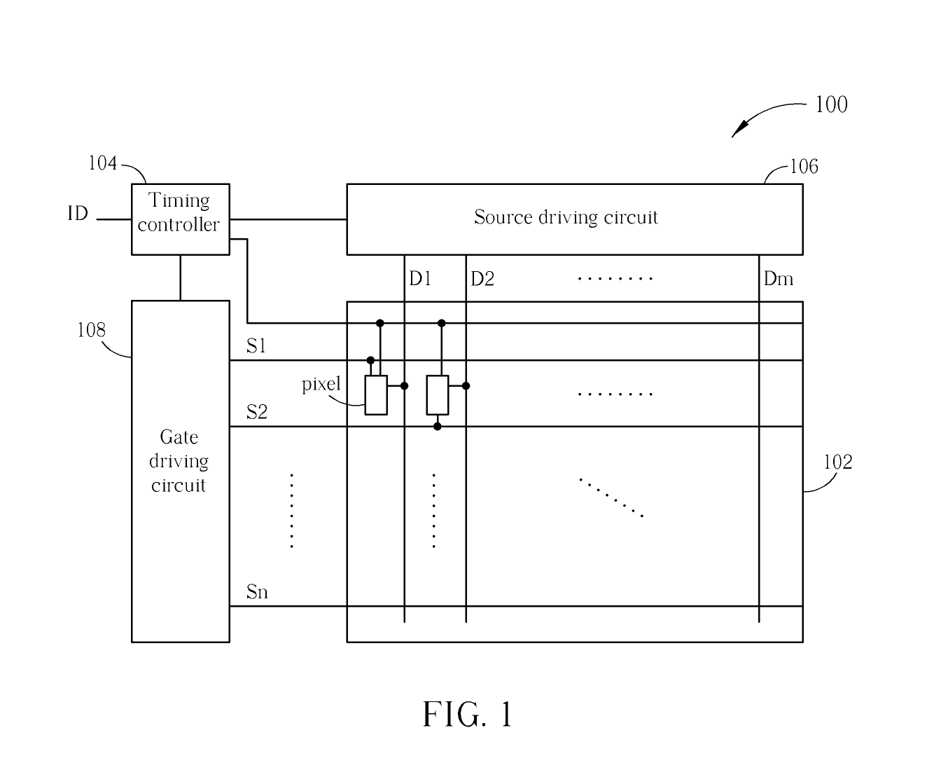

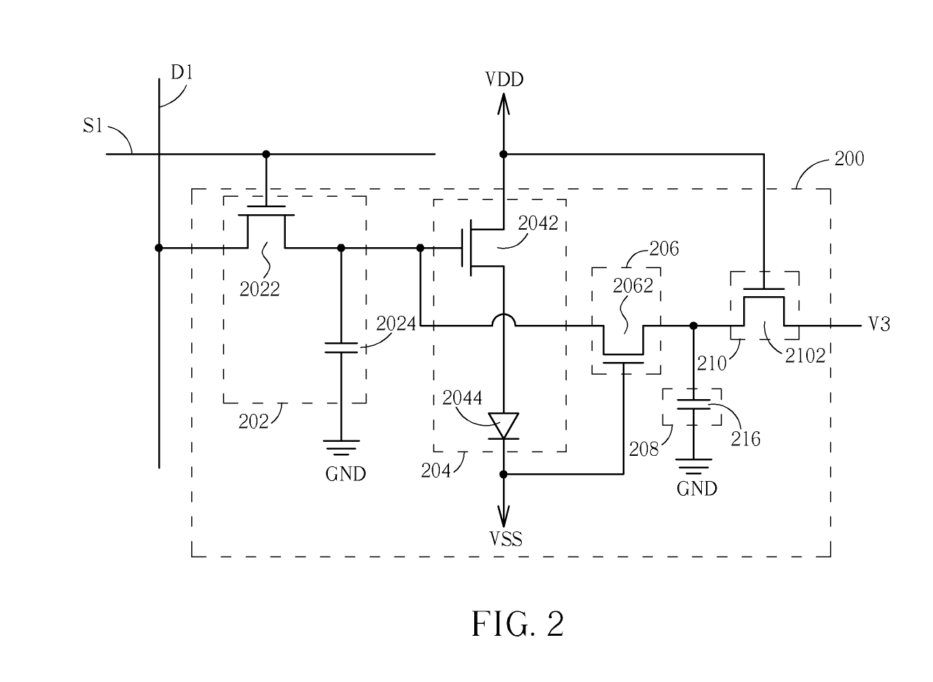

Please refer to FIG. 1 and FIG. 2. FIG. 1 is a diagram illustrating a display 100 having lighting devices integrated with an E-Book according to an embodiment, and FIG. 2 is a diagram illustrating a pixel 200. As shown in FIG. 1, the display 100 includes a display panel 102, a timing controller 104, a source driving circuit 106, and a gate driving circuit 108, where the display panel 102 includes a plurality of pixels. The timing controller 104 is used for receiving image data ID. The source driving circuit 106 is coupled to the timing controller 104 and a plurality of data lines D1-Dm, where m>1 and m is an integer. The gate driving circuit 108 is coupled to the timing controller 104 and a plurality of scan lines S1-Sn, where n>1 and n is an integer. As shown in FIG. 2, each pixel 200 includes a control unit 202, a lighting device driving unit 204, a first switch unit 206, an E-Book unit 208, and a second switch unit 210. The control unit 202 includes a first switch 2022 and a storage capacitor 2024. The first switch 2022 has a first terminal coupled to one (e.g. data line D1) of the plurality of data lines D1-Dm, a second terminal coupled to one (e.g. a scan line S1) of the plurality of scan lines S1-Sn for receiving a scan signal from the scan line S1, and a third terminal. The storage capacitor 2024 has a first terminal coupled to the third terminal of the first switch 2022, and a second terminal coupled to ground GND, where the storage capacitor 2024 is used for storing a data signal received from the data line D1. The lighting device driving unit 204 includes a second switch 2042 and a lighting device (e.g. an organic light-emitting diode) 2044. But, the present invention is not limited to the lighting device 2044 being the organic light-emitting diode. The second switch 2042 has a first terminal coupled to a second voltage terminal VDD for receiving a second high voltage signal SHV or a second low voltage signal SLV, a second terminal coupled to the first terminal of the storage capacitor 2024, and a third terminal coupled to the first terminal of the lighting device 2044. The lighting device 2044 has a first terminal coupled to the third terminal of the second switch 2042, and a second terminal coupled to a first voltage terminal VSS for receiving a first high voltage signal FHV or a first low voltage signal FLV. The first switch unit 206 coupled between the control unit 202 and the E-Book unit 208 includes a third switch 2062. The third switch 2062 has a first terminal coupled to the first terminal of the storage capacitor 2024, a control terminal coupled to the first voltage terminal VSS, and a second terminal coupled to the E-Book unit 208. The second switch unit 210 coupled between the E-Book unit 208 and a third voltage terminal V3 includes a fourth switch 2102. The fourth switch 2102 has a first terminal coupled to the E-Book unit 208, a control terminal coupled to the second voltage terminal VDD, and a third terminal coupled to the third voltage terminal V3.

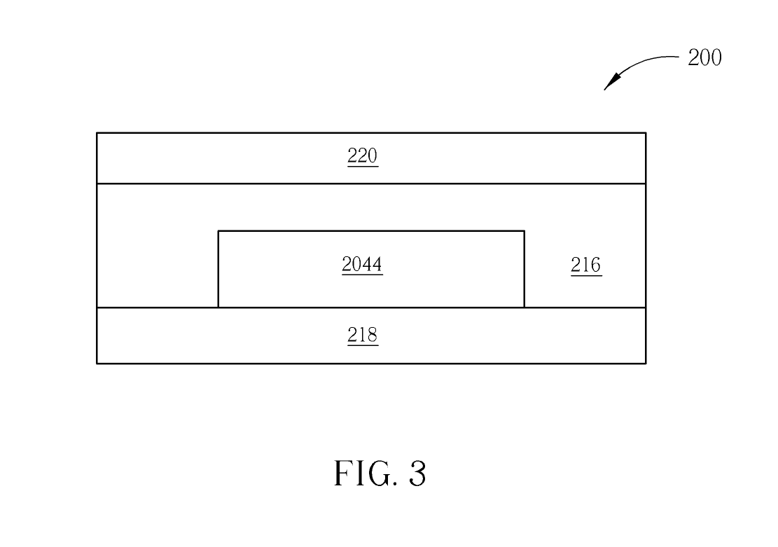

Please refer to FIG. 3. FIG. 3 is a diagram illustrating a cross-section of the pixel 200. As shown in FIG. 3, the E-Book unit 208 includes a polymer-dispersed liquid crystal (PDLC) 216 and an electrode layer (not shown in FIG. 3) for driving the PDLC 216 for instance. The PDLC 216 covers the lighting device 2044. In addition, if a designer considers simplifying a display panel process, the first switch 2022, the second switch 2042, the third switch 2062, and the fourth switch 2102 can be integrated into a circuit array 218. Furthermore, if the designer considers aperture ratios related to the allocations of the PDLC 216 and the lighting device 2044, the first switch 2022 and the second switch 2042 can be integrated into the circuit array 218, and the third switch 2062 and the fourth switch 2102 can be integrated into a circuit array 220. That is to say, the designer can flexibly integrate the first switch 2022, the second switch 2042, the third switch 2062, and the fourth switch 2102 into the circuit array 218 and the circuit array 220 according to a requirement of the designer.

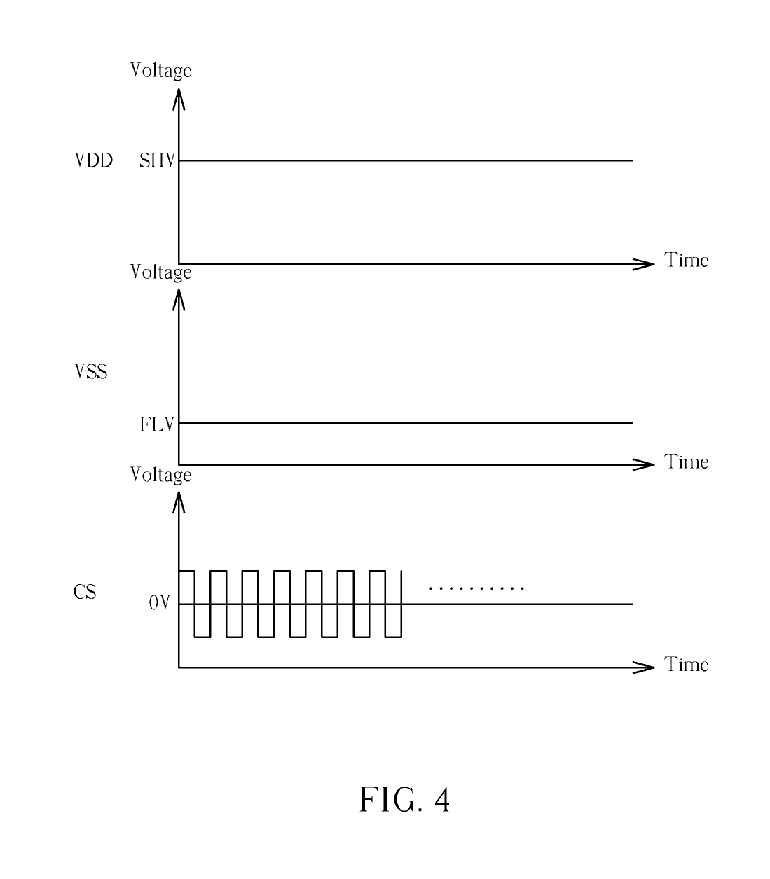

Please refer to FIG. 4. FIG. 4 is a timing diagram illustrating a first voltage signal on the first voltage terminal VSS, a second voltage signal on the second voltage terminal VDD, and a third voltage signal on the third voltage terminal V3 when the image data ID corresponds to the lighting device 2044. When the image data ID corresponds to the lighting device 2044 (e.g. a high-definition video and/or an animation), the timing controller 104 generates the first voltage signal with a first low voltage FLV, the second voltage signal with a second high voltage SHV, and a clock signal CS (the third voltage signal) , where a voltage level of the second high voltage SHV is higher than a voltage level of the first low voltage FLV. Thus, as shown in FIGS. 2-4, when the first voltage signal is at the first low voltage FLV, the second voltage signal is at the second high voltage SHV, the third voltage signal is the clock signal CS, and the gate driving circuit 108 enables the scan line S1 received by the first switch 2022, the first switch 2022, the second switch 2042, and the fourth switch 2102 are turned on, and the third switch 2062 is turned off. Thus, the storage capacitor 2024 can store a data signal provided by the source driving circuit 106 through the data line D1, and the second switch 2042 can generate a driving current (I) to drive the lighting device 2044 according to the data signal provided by the source driving circuit 106 through the data line D1. In addition, the E-Book unit 208 receives the clock signal CS through turning-on of the fourth switch 2102, and drives the PDLC 216 to generate a transparent state according to the clock signal CS. Thus, as shown in FIGS. 1 and 3, the display panel 102 can display an image which represents the image data ID through the lighting device 2044, because the PDLC 216 is at the transparent state.

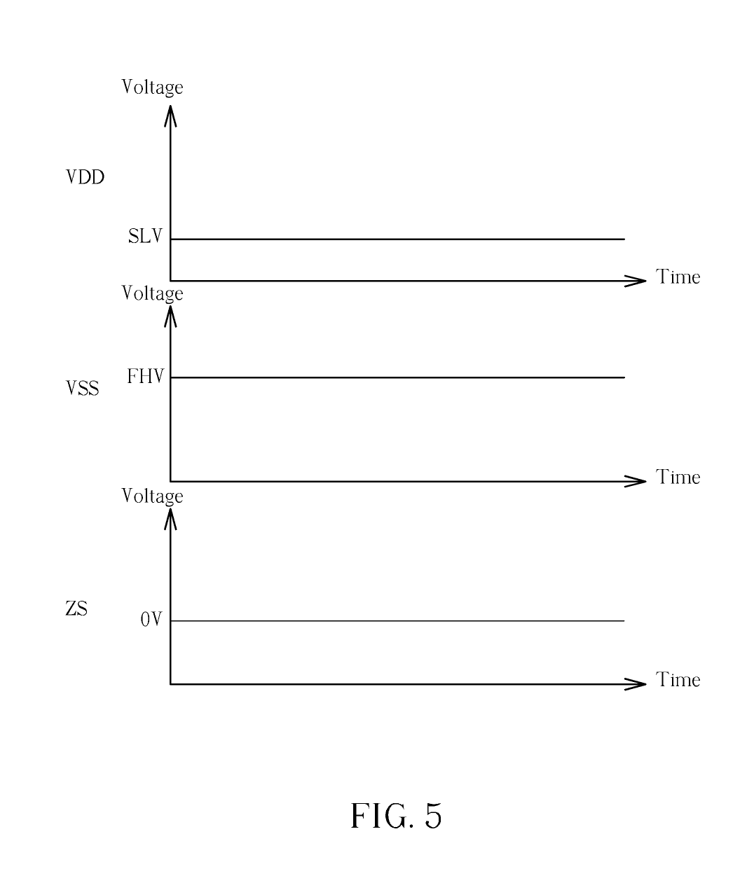

Please refer to FIG. 5. FIG. 5 is a timing diagram illustrating a first voltage signal on the first voltage terminal VSS, a second voltage signal on the second voltage terminal VDD, and a third voltage signal on the third voltage terminal V3 when the image data ID corresponds to the E-Book unit 208. When the image data ID corresponds to the E-Book unit 208, the timing controller 104 generates the first voltage signal with a first high voltage FHV, the second voltage signal with a second low voltage SLV, and a zero voltage (0V) signal ZS (the third voltage signal). Thus, as shown in FIGS. 2, 3, and 5, when the first voltage signal is at the first high voltage FHV, the second voltage signal is at the second low voltage SLV, the third voltage signal is the zero voltage signal ZS, and the gate driving circuit 108 enables the scan line S1 received by the first switch 2022, the first switch 2022 and the third switch 2062 are turned on, and the second switch 2042 and the fourth switch 2102 are turned off, where a voltage level of the first high voltage FHV is higher than a voltage level of the second low voltage SLV. Thus, the E-Book unit 208 can receive a data signal provided by the source driving circuit 106 through the data line D1 and turning-off of the first switch 2022. Meanwhile, because the second switch 2042 is turned off, the lighting device driving unit 204 does not generate a driving current (I), resulting in the lighting device 2044 not lighting. As shown in FIGS. 1-3, because the E-Book unit 208 receives the data signal provided by the source driving circuit 106, the E-Book unit 208 can drive the PDLC 216 according to the data signal. Thus, the display panel 102 can display the image which represents the image data ID through the PDLC 216.

But, the present invention is not limited to the PDLC 216. In another embodiment of the present invention, the PDLC 216 can be replaced with a cholesteric liquid crystal (CHLC), where subsequent operational principles of the CHLC are the same as those of the PDLC 216, so further description thereof is omitted for simplicity.

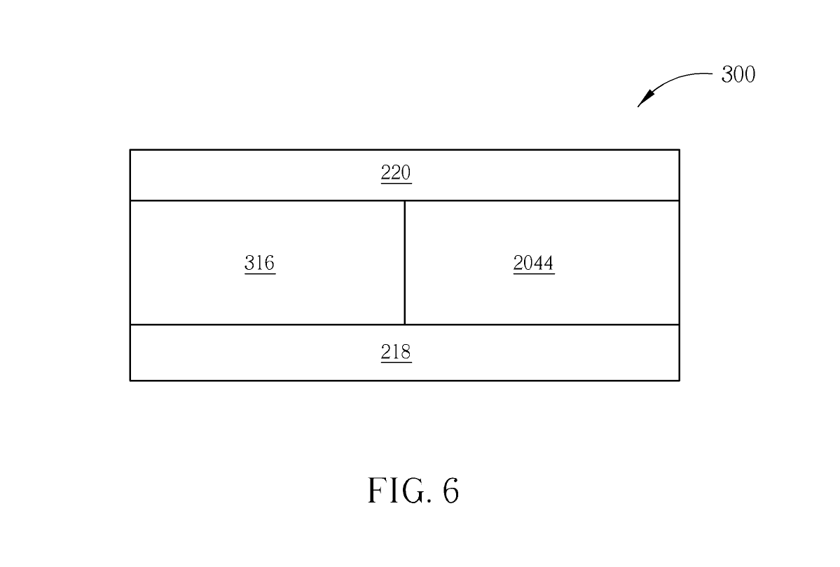

Please refer to FIG. 6. FIG. 6 is a diagram illustrating a cross-section of a pixel 300 according to another embodiment. As shown in FIG. 6, a PDLC 316 of the pixel 300 and the lighting device 2044 are located at the same plane.

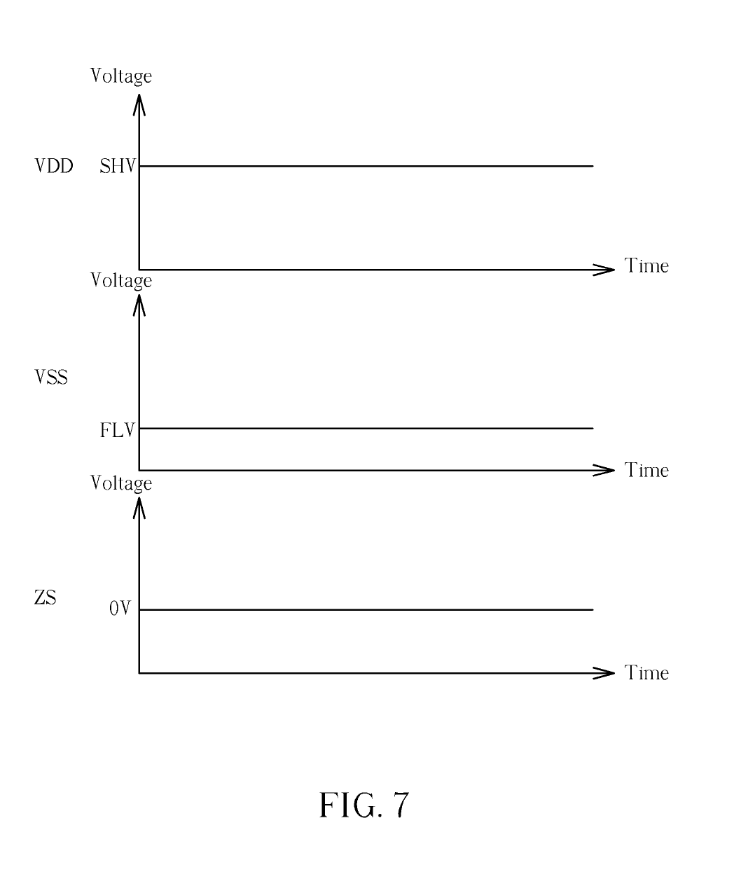

Please refer to FIG. 7. FIG. 7 is a timing diagram illustrating a first voltage signal on the first voltage terminal VSS, a second voltage signal on the second voltage terminal VDD, and a third voltage signal on the third voltage terminal V3 when image data ID corresponds to the lighting device 2044. Thus, as shown in FIGS. 2, 6, and 7, when the image data ID corresponds to the lighting device 2044 (that is, a high-definition video and/or an animation), the timing controller 104 generates the first voltage signal with a first low voltage FLV, the second voltage signal with a second high voltage SHV, and a zero voltage signal ZS (the third voltage signal), where a voltage level of the second high voltage SHV is higher than a voltage level of the first low voltage FLV. Thus, as shown in FIG. 2, FIG. 6, and FIG. 7, when the first voltage signal is at the first low voltage FLV, the second voltage signal is at the second high voltage SHV, the third voltage signal is the zero voltage signal ZS, and the gate driving circuit 108 enables the scan line S1 received by the first switch 2022, the first switch 2022, the second switch 2042, and the fourth switch 2102 are turned on, and the third switch 2062 is turned off. Thus, the storage capacitor 2024 can store a data signal provided by the source driving circuit 106 through the data line D1, and the second switch 2042 can generate a driving current (I) to drive the lighting device 2044 according to the data signal provided by the source driving circuit 106 through the data line D1. In addition, the E-Book unit 208 drives the PDLC 216 to generate a mist state according to the zero voltage signal ZS. Thus, as shown in FIG. 1 and FIG. 6, the display panel 102 can display an image which represents the image data ID through the lighting device 2044.

As shown in FIG. 7, when the image data ID corresponds to the E-Book unit 208, the timing controller 104 generates a first voltage signal with a first high voltage FHV, a second voltage signal with a second low voltage SLV, and a zero voltage (0V) signal ZS (a third voltage signal). Thus, as shown in FIGS. 2, 5, and 6, when the first voltage signal is at the first high voltage FHV, the second voltage signal is at the second low voltage SLV, the third voltage signal is the zero voltage signal ZS, and the gate driving circuit 108 enables the scan line S1 (that is, the first switch 2022 receives a scan signal), the first switch 2022 and the third switch 2062 are turned on, and the second switch 2042 and the fourth switch 2102 are turned off. Thus, the E-Book unit 208 can receive a data signal provided by the source driving circuit 106 through the data line D1 and turning-off of the first switch 2022. Meanwhile, because the second switch 2042 is turned off, the lighting device driving unit 204 does not generate a driving current (I), resulting in the lighting device 2044 not lighting. As shown in FIGS. 1, 2, and 6, because the E-Book unit 208 receives the data signal provided by the source driving circuit 106, the E-Book unit 208 can drive the PDLC 216 according to the data signal. Thus, the display panel 102 can display an image which represents the image data ID through the PDLC 216.

But, the present invention is not limited to the PDLC 316. In another embodiment of the present invention, PDLC can be replaced with the CHLC, where subsequent operational principles of the CHLC are the same as those of the PDLC 316, so further description thereof is omitted for simplicity.

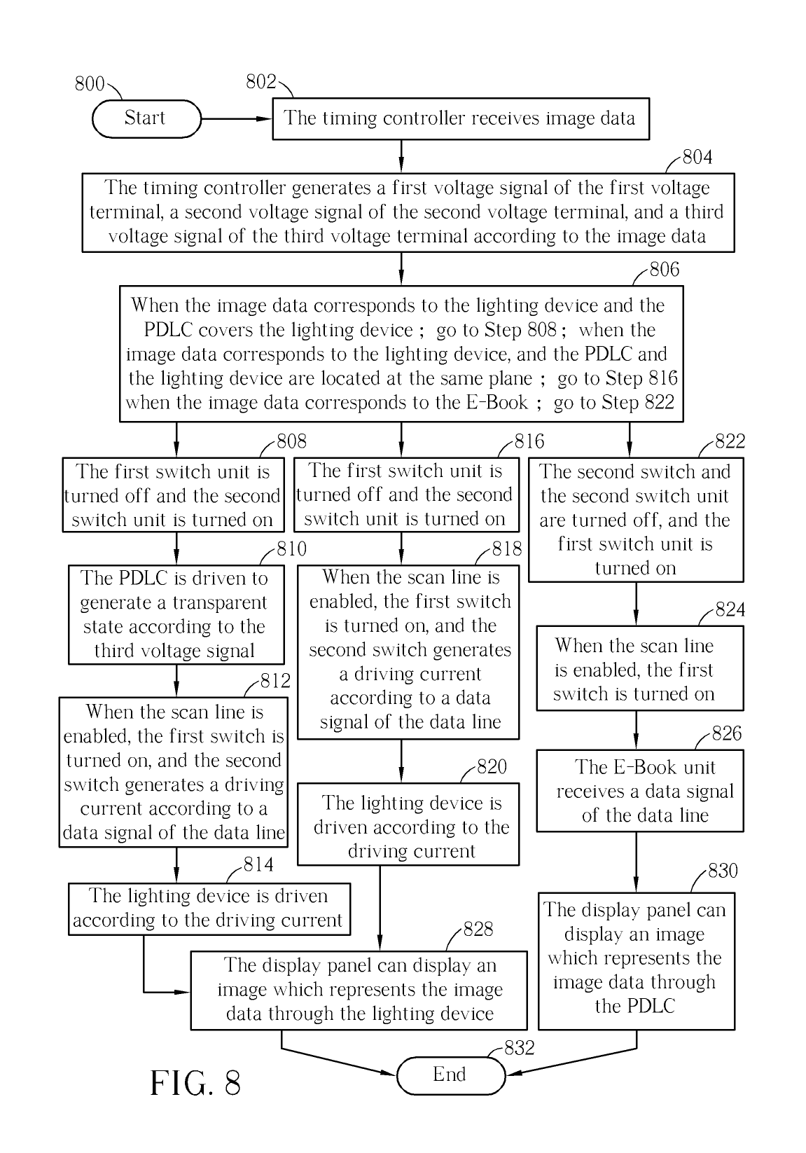

Please refer to FIG. 8. FIG. 8 is a flowchart illustrating a driving method for driving a display having lighting devices integrated with an E-Book according to another embodiment. The method in FIG. 8 is illustrated using the display 100 in FIG. 1, the pixel 200 in FIG. 2, the cross-section of the pixel 200 in FIG. 3, the timing diagrams of the first voltage signal of the first voltage terminal VSS, the second voltage signal of the second voltage terminal VDD, and the third voltage signal of third voltage terminal V3 in FIGS. 4, 5, and 7, and the cross-section of the pixel 300 in FIG. 6. Detailed steps are as follows:

Step 800: Start.

Step 802: The timing controller 104 receives image data ID.

Step 804: The timing controller 104 generates a first voltage signal of the first voltage terminal VSS, a second voltage signal of the second voltage terminal VDD, and a third voltage signal of the third voltage terminal V3 according to the image data ID.

Step 806: When the image data ID corresponds to the lighting device 2044 and the PDLC 216 covers the lighting device 2044; go to Step 808; when the image data ID corresponds to the lighting device 2044, and the PDLC 316 and the lighting device 2044 are located at the same plane; go to Step 816; when the image data ID corresponds to the E-Book; go to Step 822.

Step 808: The first switch unit 206 is turned off and the second switch unit 210 is turned on.

Step 810: The PDLC 216 is driven to generate a transparent state according to the third voltage signal.

Step 812: When the scan line S1 is enabled, the first switch 2022 is turned on, and the second switch 2042 generates a driving current (I) according to a data signal through the data line D1.

Step 814: The lighting device 2044 is driven according to the driving current (I); go to Step 828.

Step 816: The first switch unit 206 is turned off and the second switch unit 210 is turned on.

Step 818: When the scan line S1 is enabled, the first switch 2022 is turned on, and the second switch 2042 generates a driving current (I) according to a data signal through the data line D1.

Step 820: The lighting device 2044 is driven according to the driving current (I); go to Step 828.

Step 822: The second switch 2042 and the second switch unit 210 are turned off, and the first switch unit 206 is turned on.

Step 824: When the scan line S1 is enabled, the first switch 2022 is turned on.

Step 826: The E-Book unit 208 receives a data signal through the data line D1; go to Step 830.

Step 828: The display panel 102 can display an image which represents the image data ID through the lighting device 2044.

Step 830: The display panel 102 can display an image which represents the image data ID through the PDLC 216.

Step 832: End.

In Step 806, as shown in FIG. 3 and FIG. 4, when the image data ID corresponds to the lighting device 2044 and the PDLC 216 covers the lighting device 2044, the timing controller 104 generates a first voltage signal with a first low voltage FLV, a second voltage signal with a second high voltage SHV, and a clock signal CS (a third voltage signal) according to the image data ID. As shown in FIGS. 6 and 7, when the image data ID corresponds to the lighting device 2044, and the PDLC 316 and the lighting device 2044 are located at the same plane, the timing controller 104 generates a first voltage signal with a first low voltage FLV, a second voltage signal with a second high voltage SHV, and a zero voltage signal ZS (a third voltage signal) according to the image data ID. As shown in FIGS. 3, 5, and 6, when the image data ID corresponds to the E-Book unit 208, the timing controller 104 generates a first voltage signal with a first high voltage FHV, a second voltage signal with a second low voltage SLV, and a zero voltage signal ZS (a third voltage signal) according to the image data ID. In Step 808, because the first voltage signal is at the first low voltage FLV and the second voltage signal is at the second high voltage SHV, the first switch unit 206 (the third switch 2062) is turned off and the second switch unit 210 (the fourth switch 2102) is turned on. In Step 810, the E-Book unit 208 receives the clock signal CS through turning-on of the fourth switch 2102, and drives the PDLC 216 to generate a transparent state according to the clock signal CS. But, in another embodiment of the present invention, the E-Book unit 208 drives a CHLC to generate a transparent state according to the clock signal CS. In Step 812, when the scan line S1 is enabled, the first switch 2022 is turned on, so the second switch 2042 can generate the driving current (I) according to the data signal of the data line D1. In Step 816, as shown in FIGS. 3, 6, and 7, because the first voltage signal is at the first low voltage FLV, the second voltage signal is at the second high voltage SHV, the third voltage signal is the zero voltage signal ZS, the first switch unit 206 (the third switch 2062) is turned off and the second switch unit 210 (the fourth switch 2102) is turned on. Meanwhile, the E-Book unit 208 drives the PDLC 216 to generate a mist state according to the zero voltage signal ZS. But, in another embodiment of the present invention, the E-Book unit 208 drives a CHLC to generate a mist state according to the zero voltage signal ZS. In Step 822, as shown in FIGS. 2 and 5, because the first voltage signal is at the first high voltage FHV, the second voltage signal is at the second low voltage SLV, and the third voltage signal is the zero voltage signal ZS, the second switch 2042 and the second switch unit 210 (the fourth switch 2102) are turned off, and the first switch unit 206 (the third switch 2062) is turned on. Thus, as shown in FIGS. 2 and 5, in Step 826, because the first switch 2022 and the first switch unit 206 (the third switch 2062) are turned on, the E-Book unit 208 can receive the data signal provided by the source driving circuit 106 through the data line D1 and turning-on of the first switch 2022.

To sum up, the display having lighting devices integrated with an E-Book and the driving method for driving a display having lighting devices integrated with an E-Book utilize the timing controller to generate a corresponding first voltage signal, a corresponding second voltage signal, and a corresponding third voltage signal according to different image data (image data corresponding to the lighting device or image data corresponding to the E-Book). Then, the control unit, the lighting device driving unit, the first switch unit, and the second switch unit can generate a driving current to drive the lighting device, or charge the E-Book unit to a corresponding gray-level voltage according to the corresponding first voltage signal, the corresponding second voltage signal, the corresponding third voltage signal, and a data signal of a corresponding data line. Thus, compared to the prior art, the present invention can utilize advantages of a reflective panel and a lighting device panel in the same panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display having lighting devices integrated with an E-Book, the display comprising:
a display panel comprising a plurality of pixels, each pixel comprising:
a lighting device driving unit comprising a lighting device, wherein the lighting device driving unit is coupled to a first voltage terminal and a second voltage terminal respectively for generating a driving current;
a control unit coupled to the lighting device driving unit, wherein the control unit is controlled by a scan signal and used for storing a data signal;
an E-Book unit;
a first switch unit coupled between the control unit and the E-Book unit, and the first switch unit comprising a control terminal coupled to the first voltage terminal; and
a second switch unit coupled between the E-Book unit and a third voltage terminal, and the second switch unit comprising a control terminal coupled to the second voltage terminal;
wherein the lighting device driving unit generates the driving current to drive the lighting device, and the E-Book unit stores a third voltage signal received by the third voltage terminal when the first voltage terminal and the second voltage terminal receive a first low voltage signal and a second high voltage signal, respectively; and the E-Book unit receives the data signal when the first voltage terminal and the second voltage terminal receive a first high voltage signal and a second low voltage signal, respectively.

2. The display of claim 1, wherein the control unit comprises:
a first switch having a first terminal coupled to a data line, a second terminal for receiving the scan signal from a scan line, and a third terminal; and
a storage capacitor having a first terminal coupled to the third terminal of the first switch, and a second terminal coupled to ground, wherein the storage capacitor is used for storing the data signal;
the lighting device driving unit further comprises:
a second switch having a first terminal coupled to the second voltage terminal, a second terminal coupled to the third terminal of the first switch, and a third terminal coupled to a first terminal of the lighting device;
the first switch unit comprises:
a third switch having a first terminal coupled to the first terminal of the storage capacitor, a control terminal coupled to the first voltage terminal, and a second terminal coupled to the E-Book unit; and
the second switch unit comprises:
a fourth switch having a first terminal coupled to the E-Book unit, a control terminal coupled to the second voltage terminal, and a third terminal coupled to the third voltage terminal.

3. The display of claim 1, wherein the E-Book unit comprises a polymer-dispersed liquid crystal (PDLC) and the PDLC covers the lighting device, wherein the E-Book unit drives the PDLC to generate a transparent state according to the third voltage signal when the first voltage terminal and the second voltage terminal receive the first low voltage signal and the second high voltage signal, respectively, wherein the third voltage signal is a clock signal.

4. The display of claim 1, wherein the E-Book unit comprises a cholesteric liquid crystal (CHLC) and the CHLC covers the lighting device, wherein the E-Book unit drives the CHLC to generate a transparent state according to the third voltage signal when the first voltage terminal and the second voltage terminal receive the first low voltage signal and the second high voltage signal, respectively, wherein the third voltage signal is a clock signal.

5. The display of claim 1, wherein the E-Book unit comprises a PDLC, and the PDLC and the lighting device are located at the same plane, wherein the E-Book unit drives the PDLC to generate a mist state according to the third voltage signal when the first voltage terminal and the second voltage terminal receive the first low voltage signal and the second high voltage signal, respectively, wherein the third voltage signal is a zero voltage signal.

6. The display of claim 1, wherein the E-Book unit comprises a CHLC and the CHLC and the lighting device are located at the same plane, wherein the E-Book unit drives the CHLC to generate a mist state according to the third voltage signal when the first voltage terminal and the second voltage terminal receive the first low voltage signal and the second high voltage signal, respectively, wherein the third voltage signal is a zero voltage signal.

7. A driving method for driving a display having lighting devices integrated with an E-Book, each pixel of the display comprising a control unit, a lighting device driving unit, a first switch unit, a second switch unit, and an E-Book unit, the lighting device driving unit comprising a lighting device, the method comprising:
receiving image data;
generating a first voltage signal, a second voltage signal, and a third voltage signal according to the image data; and
the control unit, the lighting device driving unit, the first switch unit, the E-Book unit, and the second switch unit executing corresponding operations according to the first voltage signal, the second voltage signal, and the third voltage signal.

8. The method of claim 7, wherein generating the first voltage signal, the second voltage signal, and the third voltage signal according to the image data is generating the first voltage signal with a first low voltage, the second voltage signal with a second high voltage, and the third voltage signal with a clock signal when the image data corresponds to the lighting device.

9. The method of claim 8, wherein the control unit, the lighting device driving unit, the first switch unit, the E-Book unit, and the second switch unit executing the corresponding operations according to the first voltage signal, the second voltage signal, and the third voltage signal comprises:
turning off the first switch unit and turning on the second switch unit according to the first voltage signal with the first low voltage and the second voltage signal with the second high voltage;
turning on a first switch included in the control unit and a second switch included in the lighting device driving unit generating a driving current according to a data signal of a data line when a scan line is enabled; and
driving the lighting device according to the driving current.

10. The method of claim 9, further comprising:
driving a PDLC or a CHLC to generate a transparent state according to the clock signal.

11. The method of claim 7, wherein generating the first voltage signal, the second voltage signal, and the third voltage signal according to the image data is generating the first voltage signal with a first low voltage, the second voltage signal with a second high voltage, and the third voltage signal with a zero voltage when the image data corresponds to the lighting device.

12. The method of claim 11, wherein the control unit, the lighting device driving unit, the first switch unit, the E-Book unit, and the second switch unit executing the corresponding operations according to the first voltage signal, the second voltage signal, and the third voltage signal comprises:
turning off the first switch unit and turning on the second switch unit according to the first voltage signal with the first low voltage and the second voltage signal with the second high voltage;
turning on a first switch included in the control unit and a second switch included in the lighting device driving unit generating a driving current according to a data signal of a data line when a scan line is enabled; and
driving the lighting device according to the driving current.

13. The method of claim 11, further comprising:
driving a PDLC or a CHLC to generate a mist state according to the third voltage signal with the zero voltage.

14. The method of claim 7, wherein generating the first voltage signal, the second voltage signal, and the third voltage signal according to the image data is generating the first voltage signal with a first high voltage, the second voltage signal with a second low voltage, and the third voltage signal with a zero voltage when the image data is image data corresponding to the E-Book unit.

15. The method of claim 14, wherein the control unit, the lighting device driving unit, the first switch unit, the E-Book unit, and the second switch unit executing the corresponding operations according to the first voltage signal, the second voltage signal, and the third voltage signal comprises:
turning off a second switch included in the lighting device driving unit and the second switch unit, and turning on the first switch unit according to the first voltage signal with the first high voltage and the second voltage signal with the second low voltage;
turning on a first switch included in the control unit when a scan line is enabled; and
the E-Book unit receiving a data signal of a data line.
